(19) United States
(12) Patent Application Publication
(10) Pub. No.: US 2004/0104153 A1
(43) Pub. Date: Jun. 3, 2004

(54) Portable water purifier

(76) Inventor: Chung-Hsiang Yang, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/306,218

(22) Filed: Nov. 29, 2002

(51) Int. Cl. B01D 35/14

(52) U.S. Cl. 210/136; 210/241; 210/258; 210/259; 210/321.72; 210/335

(57) ABSTRACT

A portable water purifier having a housing, a handle, an input tube, an output valve, a power supply line, and a water purification system. This water purification system includes a preliminary filter, a pump, two reverse osmosis units and a discharge tube. The preliminary filter can be placed in a river or a lake. The power supply line can connect to an electric energy source, such as electric generator, solar electric generator, and so on. So, it is very convenient to use it indoors or outdoors.

### BACKGROUND OF INVENTION

1. Field of the Invention

This invention relates to a water purifier. Particularly, it relates to a portable water purifier that is easy to carry outdoors and it can connect to an electric energy source.

2. Description of the Prior Art

The reverse osmosis method is commonly used in current water purifiers, especially in factories, corporations, families, etc. However, the current water purifier contains a pressurized water storage container. The volume of the pressurized water storage container is quite big, so usually it is installed indoors. Thus, the size of the container is one of its disadvantages. And, once the water purifier is installed, it is hard to move. Besides, when a disaster happens (such as earthquake, flood, tornado, etc.), the public power system or water supply system will break down. So, without electricity or clean water, this kind of water purifier becomes useless. Consequently, under such bad sanitary environment, people might get some infectious diseases by drinking dirty water. Similarly, the campers, mountaineers and explorers will face the same problem.

### SUMMARY OF THE INVENTION

The present invention is to provide a portable water purifier that is easy to carry outdoors. With the design of a handle, an input tube with a preliminary filter, and a power supply line for connecting with an electric energy source, this invention can connect to an electric generator, a solar electric generator, a car's cigarette lighter seat, or a rechargeable battery. Thus, the pump can pump up the water from a river or a lake to proceed the reverse osmosis filtering. Hence, this invention can be used indoors or outdoors.

### BRIEF DESCRIPTION OF THE DRAWINGS

FIG. 1 is a perspective view of this invention.

FIG. 2 illustrates the first preferred embodiment of this invention.

FIG. 3 illustrates the second preferred embodiment of this invention.

FIG. 4 is a perspective view showing this invention that is connected to an electric generator.

FIG. 5 is a perspective view showing this invention that is connected to a solar electric generator.

### DETAILED DESCRIPTION OF THE PREFERRED EMBODIMENT

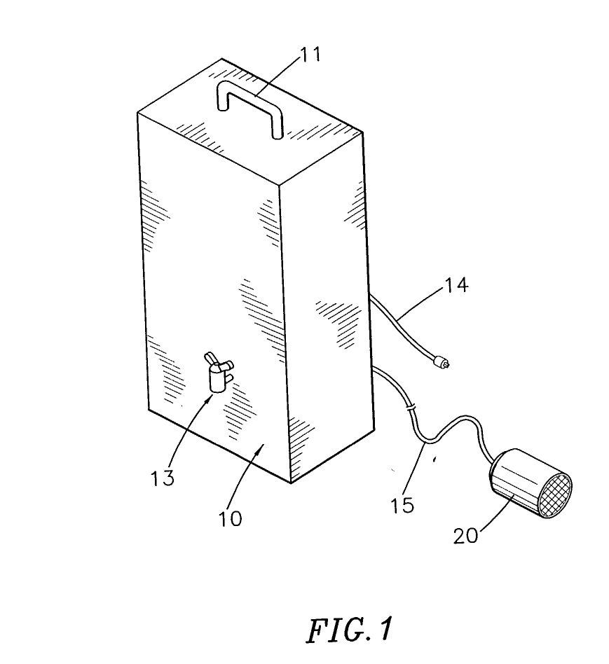

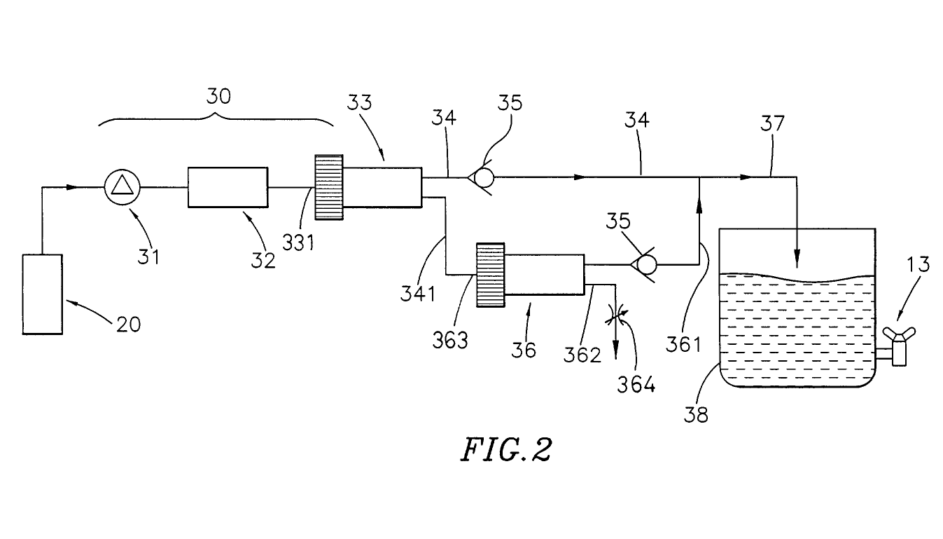

This invention relates to a portable water purifier. As shown in FIGS. 1 and 2, the portable water purifier 10 comprises a housing, a handle 11, an input tube 15, an output valve 13, a power supply line 14, and a water purification system 30.

This handle 11 is disposed on a top surface of the housing. The input tube 15 is used for feeding water in. The output valve 13 is to discharge purified water. This power supply line 14 is to connect with an electric energy source.

With regard to the water purification system 30, it is disposed inside the housing. The water purification system 30 includes a preliminary filter 20, a pump 31, two reverse osmosis units 33, 36 and a discharge tube 37. The preliminary filter 20 is disposed on the input tube 15. The pump 31 is connected to the input tube 15 for pumping water in. An activated carbon filter 32 is disposed between the pump 31 and these two reverse osmosis units 33, 36.

One of the reverse osmosis units that is labeled 33 includes a first inlet 331, a first main outlet 34 and a first sub outlet 341. The other reverse osmosis unit that is labeled 36 includes a second inlet 363, a second main outlet 361 and a second sub outlet 362. The first inlet 331 is connected to the activated carbon filter 32. The first main outlet 34 is disposed with a check valve 35 and then connected to the discharge conduit 37. The first sub outlet 341 is connected to the second inlet 363. The second main outlet 361 is disposed with another check valve 35 and then connected to the discharge conduit 37. The second sub outlet 362 is to discharge waste water. And, the discharge conduit 37 guides water into a pure water storage container 38 which is connected to the output valve 13. The function of the check valves 35 is to prevent the purified water flowing back. In addition, there is an adjustable valve 364 that can adjust the ratio of pure water and waste water.

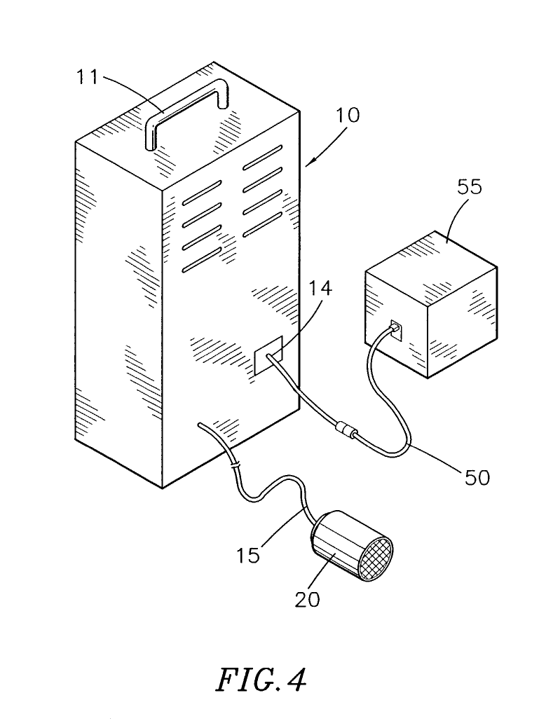

In operation, referring to FIGS. 1, 2, and 4, the user can use this invention outdoors. In fact, the user can put this preliminary filter 20 into a river or a lake. Then, the power supply line 14 is connected to an electric connector 50 of an electric generator 55. The electric generator 55 will provide the electricity to drive the pump 31 working. So, the water in the river or the lake will be pumped into the preliminary filter 20 in order to filter out the solid particles. Then, the activated carbon filter 32 will further filter out other smaller particles. After the water passing through the activated carbon filter 32, it enters the reverse osmosis unit 33 for starting the reverse osmosis filtering process. The pure water in the first main outlet 34 will flow to the discharge conduit 37. The waste water in the first sub outlet 341 will flow to the second inlet 363 of the reverse osmosis unit 36 to proceed the second reverse osmosis filtering process. After which, the water in the second main outlet 361 will flow to the discharge conduit 37. The waste water in the second sub outlet 362 will flow to a specific container (not shown).

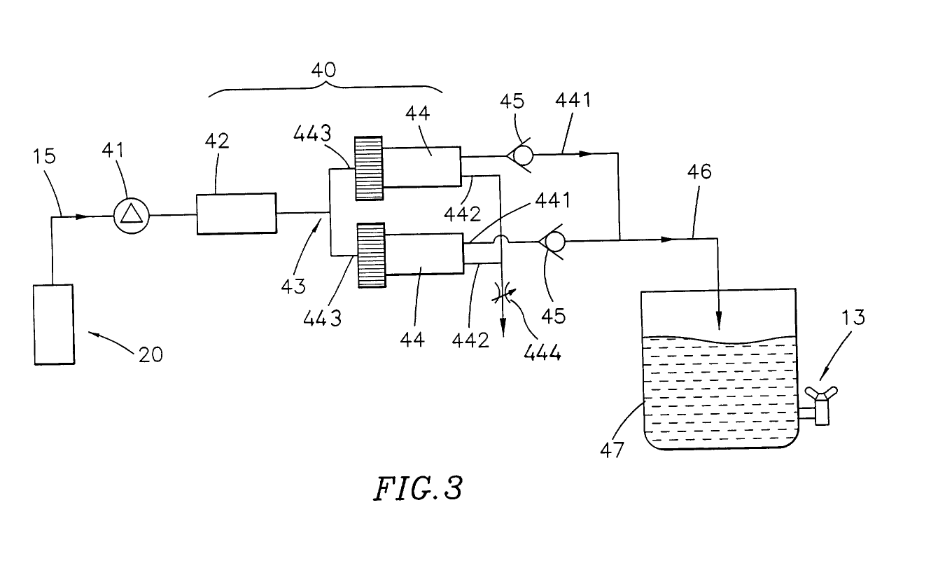

In addition, please see FIG. 3. This is another embodiment of the invention. The reverse osmosis units 33,36 shown in FIG. 2 are in the serial-typed arrangement. But, the reverse osmosis units 44,44 shown in FIG. 3 are in the parallel-typed arrangement. Again, as shown in FIG. 3, the water purification system 40 still includes a preliminary filter 20, a pump 41, an activated carbon filter 42, two (or more) reverse osmosis units 44, 44 and a discharge tube 46. The preliminary filter 20 is disposed on the input tube 15. The pump 41 is connected to the input tube 15 for pumping water in. Moreover, each reverse osmosis unit 44 includes an inlet 443, a main outlet 441 and a sub outlet 442. A three-way (or multi-way) connector 43 is disposed between the activated carbon filter 42 and these two inlets 443 of the reverse osmosis unit 44. The main outlets 441 are connected to check valves 45 respectively and then connected to the same discharge conduit 46. The sub outlets 442 are merged and connected to an adjustable valve 444 to discharge waster. And, the discharge conduit 46 guides purified water into a pure water storage container 47 that is connected to the output valve 13. Of course, the waste water in the sub outlets 442 will flow to a specific container (not shown).

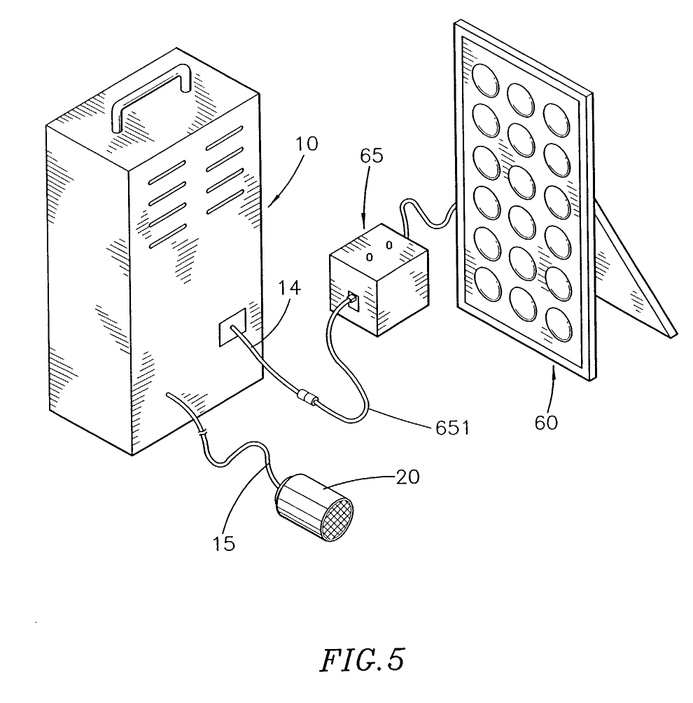

In addition, referring to FIG. 5, this invention can connect to a solar electric generator 60 as one of the electric energy sources. In which, the power supply line 14 is connected to an extension line 651 of an electricity converter 65 of the solar electric generator 60. The solar electric generator 60 will provide the power to drive the pump 31 working. So, the water in a river or a lake will be pumped into the preliminary filter 20

Beside, the three-way connector 45 can be substantially T-shaped and is disposed after the activated carbon filter 42. Also, the cigarette lighter seat (not shown) of an automobile (not shown) can be another possible device of the electric energy sources. A rechargeable battery (not shown) can be used, too. However, if this invention is used indoors, the power supply line 14 can connect to an electric socket (not shown) via a transformer (not shown) in a house.

In summary, this invention has the following characteristics:

(1) It complete improves the disadvantages of the existing fixed indoor water purifier. The user can carry this invention outdoors via its handle. So, it is portable and very convenient.

(2) When a disaster (such as earthquake, flood, tornado, etc.) happens, the public water supply system might be destroyed. At this time, the user can use put the input tube of this invention into a river or a lake. After the water is filtered, the outdoor water becomes drinkable.

(3) When a disaster or a war happens, the public sanitary condition in this area will get worse. However, the reverse osmosis units of this invention can effectively filter out most germs in the water so that it will significantly protect the user's health.

(4) This invention can use the solar electric generator, electric generator, automobile's cigarette lighter seat or a rechargeable battery, so its application scope is wide and it is very suitable for military soldiers, mountaineers, campers, explorers, etc.

(5) This invention also can be used indoors by using a transformer. The input tube can connect to a faucet. Thus, this invention also can be used indoors.

The above embodiments are only used to illustrate the present invention, not intended to limit the scope thereof. Many modifications of the above embodiments can be made without departing from the spirit of the present invention.

What is claimed is:

1. A portable water purifier comprising:
a housing;
a handle disposed on a top surface of said housing;
an input tube for feeding water in;
an output valve for discharging purified water;
a power supply line for connecting with an electric energy source; and
a water purification system disposed inside said housing, said water purification system including a preliminary filter, a pump, at least two reverse osmosis units and a discharge tube, said preliminary filter being disposed on said input tube, said pump being connected to said input tube, said two reverse osmosis units being disposed between said pump and said discharge tube, said discharge tube being connected to said output valve.

2. A portable water purifier as claimed in claim 1, wherein an activated carbon filter is disposed between said pump and said reverse osmosis units.

3. A portable water purifier as claimed in claim 2, wherein one of said reverse osmosis units includes a first inlet, a first main outlet and a first sub outlet, the other reverse osmosis unit includes a second inlet, a second main outlet and a second sub outlet; said first inlet is connected to said activated carbon filter, said first main outlet is disposed with a check valve and then connected to said discharge conduit, said first sub outlet is connected to said second inlet, said second main outlet is disposed with another check valve and then connected to said discharge conduit, said second dub outlet is to discharge waste water, and said discharge conduit guides water into a pure water storage container which is connected to said output valve.

4. A portable water purifier as claimed in claim 2, wherein each reverse osmosis unit includes an inlet, a main outlet and a sub outlet; a three-way connector is disposed among said activated carbon filter and said inlets of said reverse osmosis units, said main outlets are disposed with check valves respectively and then connected to said discharge conduit, said sub outlets are connected to discharge waster, and said discharge conduit guides water into a pure water storage container which is connected to said output valve.

5. A portable water purifier as claimed in claim 4, wherein said three-way connector is substantially T-shaped and is disposed after said activated carbon filter.

6. A portable water purifier as claimed in claim 1, wherein said electric energy source is an electric generator.

7. A portable water purifier as claimed in claim 1, wherein said electric energy source is a solar electric generator.
